(19) United States
(12) Patent Application Publication
(10) Pub. No.: US 2023/0099347 A1
(43) Pub. Date: Mar. 30, 2023

(54) LIGHTING DEVICE

(71) Applicant: TOYODA GOSEI CO., LTD., Kiyosu-shi (JP)

(72) Inventors: Kanae MATSUMURA, Kiyosu-shi (JP); Yasutsugu SUGIURA, Kiyosu-shi (JP)

(21) Appl. No.: 17/884,692

(22) Filed: Aug. 10, 2022

(30) Foreign Application Priority Data
Sep. 27, 2021 (JP) 2021-156805

(51) Int. Cl. B60Q 3/74; B60Q 3/62

(52) U.S. Cl. CPC B60Q 3/74; B60Q 3/62

(57) ABSTRACT

A lighting device to be installed on an instrument panel in a vehicle cabin. The lighting device is configured to emit light in a first direction toward a seat in the vehicle cabin so as to be directly visually perceived by an occupant sitting in the seat and to emit light in a second direction toward an interior of the vehicle cabin so as to be reflected by the interior and then visually perceived by the occupant.

### CROSS-REFERENCE TO RELATED APPLICATION

The present patent application claims the priority of Japanese patent application No. 2021/156805 filed on Sep. 27, 2021, and the entire contents of Japanese patent application No. 2021/156805 are hereby incorporated by reference.

### TECHNICAL FIELD

The present invention relates to a lighting device used in a vehicle cabin.

### BACKGROUND ART

A lighting device installed on an instrument panel in a vehicle cabin and used as indirect lighting is known (see Patent Literature 1). The lighting device described in Patent Literature 1 has a lighting member with light-guiding properties arranged on an instrument panel at the front of the vehicle cabin, and is configured such that illumination light from the lighting member is emitted toward a surface below a stepped portion of the instrument panel so as not to directly come into view of a driver setting in a front seat in the vehicle cabin.

### CITATION LIST

### Patent Literature

Patent Literature 1: JP 4407455 B

### SUMMARY OF INVENTION

Lighting devices used as indirect lighting, such as the lighting device described in Patent Literature 1, are generally low in brightness and are mainly used for ambient illumination (ambient lighting). Therefore, the known light devices are difficult to use as a notifier.

It is an object of the invention to provide a lighting device that can be used as a versatile lighting device while being installed on the instrument panel in the vehicle cabin.

According to an aspect of the invention, a lighting device defined by (1) to (3) below is provided.

(1) A lighting device to be installed on an instrument panel in a vehicle cabin, wherein the lighting device is configured to emit light in a first direction toward a seat in the vehicle cabin so as to be directly visually perceived by an occupant sifting in the seat and to emit light in a second direction toward an interior of the vehicle cabin so as to be reflected by the interior and then visually perceived by the occupant.

(2) The lighting device according to (1) comprises:
a light source that emits light; and
a light guide that takes in light emitted from the light source and allows the light to propagate therethrough and to be output,
wherein the light guide comprises a first prism to reflect and output light propagating therethrough in the first direction, and a second prism to reflect and output light propagating therethrough in the second direction.

(3) The lighting device according to (2), further comprising:
an outer lens comprising a material transparent to light emitted from the light source,
wherein the outer lens comprises a first flat plate portion to transmit the light output from the light guide in the first direction and a second flat plate portion to transmit the light output from the light guide in the second direction.

### Advantageous Effects of Invention

According to an embodiment of the invention, a lighting device can be provided that can be used as a versatile lighting device while being installed on the instrument panel in the vehicle cabin.

### BRIEF DESCRIPTION OF DRAWINGS

FIG. 1 is a schematic diagram illustrating the periphery of an instrument panel in a vehicle cabin to show an installation location of a lighting device in an embodiment of the present invention.

FIG. 2 is a vertical cross-sectional view showing the instrument panel on which the lighting device in the embodiment of the invention is installed.

FIG. 3 is an exploded perspective view showing a configuration of the lighting device in the embodiment of the invention.

FIG. 4 is a vertical cross-sectional view showing the instrument panel on which a modification of the lighting device in the embodiment of the invention is installed.

### DESCRIPTION OF EMBODIMENTS

### Embodiment

A lighting device 1 in the embodiment of the invention is a lighting device installed on an instrument panel in a vehicle cabin, emits light in a first direction D1 toward a seat in the vehicle cabin so as to be directly visually perceived by an occupant sitting in the seat and emits light in a second direction D2 toward an interior of the vehicle cabin so as to be reflected by the interior and then visually perceived by the occupant.

That is, the lighting device 1 has both a direct lighting function by the light output in the first direction D1 and an indirect lighting function by the light output in the second direction D2. For example, the light output in the first direction D1 as direct lighting has high brightness and is thus mainly used for a function of visual notification to vehicle occupants, such as warning to a driver, while the light output in the second direction D2 as indirect lighting can produce a variety of effects by a pattern or color of a surface of an interior part reflecting light and is thus mainly used for ambient illumination applications.

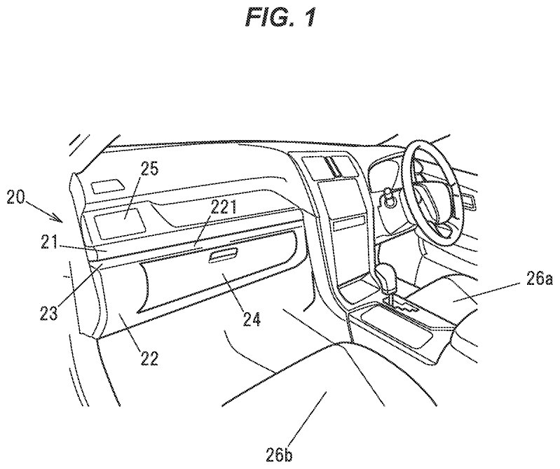

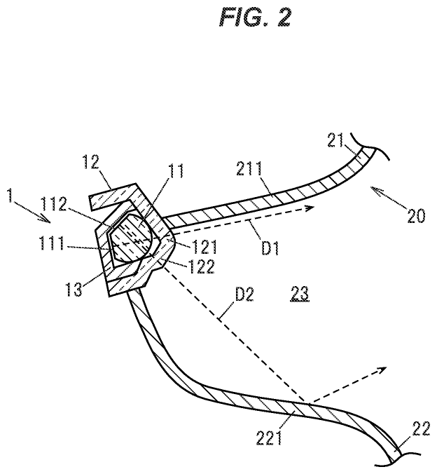

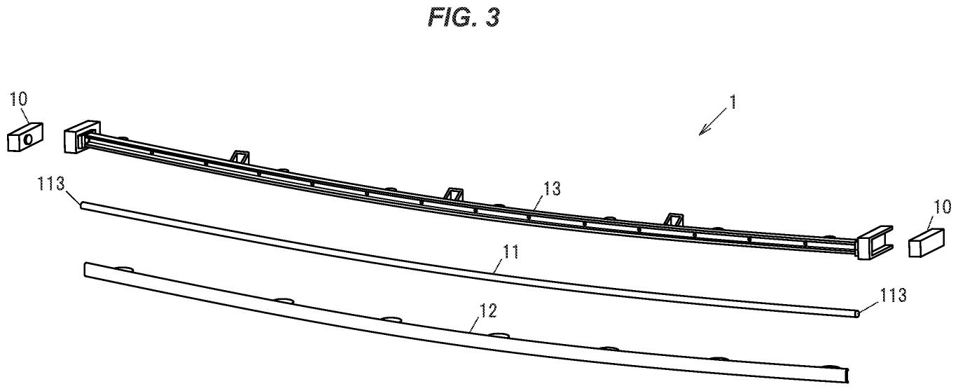

FIG. 1 is a schematic diagram illustrating the periphery of an instrument panel 20 in a vehicle cabin to show an installation location of the lighting device 1. FIG. 2 is a vertical cross-sectional view showing the instrument panel 20 on which the lighting device 1 is installed. FIG. 3 is an exploded perspective view showing a configuration of the lighting device 1.

The instrument panel 20 is a vehicle interior part which is arranged in front of seats 26 (a driver's seat 26a, a front passenger seat 26b) and on which vehicle meters and gauges and air conditioner vents, etc., are provided. The instrument panel 20 has an upper panel 21 constituting an upper portion thereof, and a lower panel 22 constituting a lower portion. For example, a glove compartment 24, etc., is provided on the lower panel 22 in front of the front passenger seat, and an air conditioner vent 25, etc., is provided on the upper panel 21.

A space 23, which opens on the seat 26 side and extends in a vehicle width direction, is provided between the upper panel 21 and the lower panel 22 arranged thereunder. Here, regarding surfaces defining the space 23, a surface of the upper panel 21 located on the lower side is referred to as a lower surface 211, and a surface of the lower panel 22 located on the upper side is referred to as an upper surface 221.

As shown in FIG. 2, the lighting device 1 is installed in the space 23 of the instrument panel 20, and light emitted from the lighting device 1 is output from the space 23 toward the seat 26 in the vehicle cabin.

The first direction D1 is a direction toward an opening of the space 23, and much of the light output in the first direction from the lighting device 1 does not travel toward the interior parts such as the upper panel 21 or the lower panel 22 but travels directly toward the seat 26 without being reflected by the interior parts. On the other hand, the second direction D2 is a diagonally downward direction, and much of the light output in the second direction from the lighting device 1 is diagonally incident on and reflected at the upper surface 221 of the lower panel 22 and then travels toward the seat 26.

The lighting device 1 includes light-emitting devices 10 as light sources, a rod-shaped light guide 11 that takes in light emitted from the light-emitting devices 10 and allows the light to propagate therethrough and to be output, an outer lens 12 that can transmit the light emitted from the light-emitting devices 10, and a housing 13 to house the light guide 11, fix the light-emitting devices 10 to both ends of the light guide 11, and fix the outer lens 12 on a light extraction side of the light guide 11. The lighting device 1 is attached in the space 23 so that a longitudinal direction of the light guide 11 is along a longitudinal direction of the space 23 (the vehicle width direction).

The light-emitting device 10 includes a light-emitting element such as LED. The light-emitting element included in the light-emitting device 10 is, e.g., an LED called a full-color LED having three LEDs of red, green and blue colors in one package, and in this case, light of a desired color can be emitted by, e.g., PWM control from an in-vehicle ECU (Electronic Control Unit) through an in-vehicle network.

The light guide 11 is formed of a material which can transmit the light emitted from the light-emitting device 10, such as clear acrylic. The light guide 11 has a first prism 111 to reflect and output light propagating therethrough in the first direction D1, and a second prism 112 to reflect and output light propagating therethrough in the second direction D2, as shown in FIG. 2. Each of the first prism 111 and the second prism 112 is provided along a length direction of the light guide 11.

The first prism 111 is composed of, e.g., a group of linear grooves which are aligned on a flat surface oriented toward the opening of the space 23 and each extends along a direction orthogonal to the length direction of the light guide 11. The second prism 112 is composed of, e.g., a group of linear grooves which are aligned on a flat surface oriented toward the upper surface 221 of the lower panel 22 and each extends along a direction orthogonal to the length direction of the light guide 11.

The linear grooves constituting the first prism 111 and the second prism 112 are, e.g., straight grooves having a V-shaped cross section. Alternatively, the first prism 111 and the second prism 112 may be composed of a group of linear protrusions, in place of the group of linear grooves. The linear protrusions in this case are, e.g., straight protrusions having a triangular cross section.

The light guide 11 is a rod-shaped light guide which has a circular or polygonal cross section and on which the first prism 111 and the second prism 112 are provided. The light guide 11 may be curved to match a surface shape of the instrument panel 20.

In the configuration shown in FIG. 3, end faces 113 on both sides of the light guide 11 serve as light intake surfaces. Light emitted from the light-emitting devices 10 enters into the light guide 11 from the end faces 113 on both sides and propagates in the length direction of the light guide 11. Light propagating inside the light guide 11 is output in the first direction D1 from the light guide 11 by being reflected at the first prism 111, and is output in the second direction D2 from the light guide 11 by being reflected at the second prism 112.

The outer lens 12 is formed of a material which can transmit the light emitted from the light-emitting device 10, such as PC (polycarbonate). The outer lens 12 has a first flat plate portion 121 to transmit the light output from the light guide 11 in the first direction D1 and a second flat plate portion 122 to transmit the light output from the light guide 11 in the second direction D2.

The first flat plate portion 121 is positioned opposite the first prism 111 (so as to be substantially parallel to the flat surface on which the first prism 111 is provided) to increase transmittance of the light output from the light guide 11 in the first direction D1. Likewise, the second flat plate portion 122 is positioned opposite the second prism 112 (so as to be substantially parallel to the flat surface on which the second prism 112 is provided) to increase transmittance of the light output from the light guide 11 in the second direction D2.

The outer lens 12 is provided to cover the light extraction side of the light guide 11 so that the longitudinal direction thereof is along the longitudinal direction of the light guide 11. In case that the light guide 11 is curved to match the surface shape of the instrument panel 20, the outer lens 12 is also curved to match the shape of the light guide 11.

Portions of the outer lens 12 other than the first flat plate portion 121 and the second flat plate portion 122 may be colored black or white by painting, etc., so as not to transmit the light emitted from the light-emitting devices 10.

The housing 13 is formed of a material which does not transmit the light emitted from the light-emitting devices 10, such as PCABS colored black or white.

### (Modification)

The configuration of the lighting device of the invention to emit light in the first direction D1 and the second direction D2 is not limited to the configuration of using the light guide 11 having the first prism 111 and the second prism 112, which is the configuration of the lighting device 1.

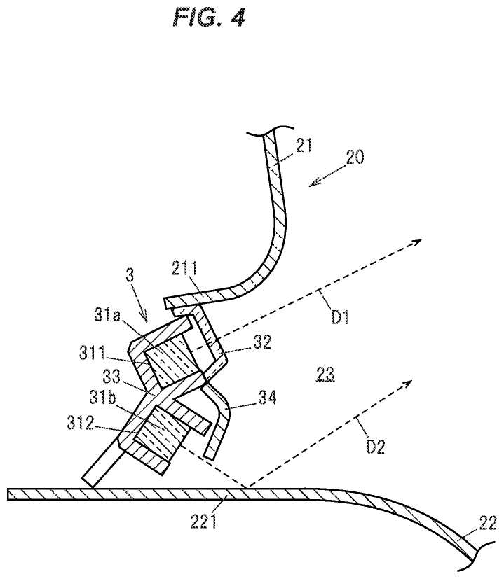

FIG. 4 is a vertical cross-sectional view showing the instrument panel 20 on which a lighting device 3, which is a modification of the lighting device 1, is installed. The lighting device 3 is different from the lighting device 1 in that two light guides, a rod-shaped light guide 31a to output light in the first direction D1 and a rod-shaped light guide 31b to output light in the second direction D2, are provided. The lighting device 3 is installed in the space 23 of the instrument panel 20 in the same manner as the lighting device 1.

The lighting device 3 includes the light-emitting devices 10 as the light sources, the rod-shaped light guides 31a and 31b that take in light emitted from the light-emitting devices 10 and allow the light to propagate therethrough and to be output, an outer lens 32 that can transmit the light output from the light guide 31a, an outer cover 34 that blocks a portion of light output from the light guide 31b to limit an illumination range, and a housing 33 to house the light guides 31a and 31b, fix the light-emitting devices 10 to both ends of the light guides 31a and 31b, and fix the outer lens 32 and the outer cover 34 on the light extraction side of the light guides 31a and 31b.

The light guides 31a and 31b are, e.g., aligned vertically so that the light guide 31a to output light in the first direction D1 is located on the upper side and the light guide 31b to output light in the second direction D2 is located on the lower side, as shown in FIG. 4.

The light guides 31a and 31b are formed of a material which can transmit the light emitted from the light-emitting device 10, such as clear acrylic. The light guide 31a has a first prism 311 to reflect and output light propagating therethrough in the first direction D1, and the light guide 31b has a second prism 312 to reflect and output light propagating therethrough in the second direction D2, as shown in FIG. 4. The first prism 311 is provided along a length direction of the rod-shaped light guide 31a, and the second prism 312 is provided along a length direction of the rod-shaped light guide 31b.

The first prism 311 is composed of, e.g., a group of linear grooves which are aligned on a flat surface oriented toward the opening of the space 23 and each extends along a direction orthogonal to the length direction of the light guide 31a. The second prism 312 is composed of, e.g., a group of linear grooves which are aligned on a flat surface oriented toward the upper surface 221 of the lower panel 22 and each extends along a direction orthogonal to the length direction of the light guide 31b.

The linear grooves constituting the first prism 311 and the second prism 312 are, e.g., straight grooves having a V-shaped cross section. Alternatively, the first prism 311 and the second prism 312 may be composed of a group of linear protrusions, in place of the group of linear grooves. The linear protrusions in this case are, e.g., straight protrusions having a triangular cross section.

The light guide 31a is a rod-shaped light guide which has a circular or polygonal cross section and on which the first prism 311 is provided, and the light guide 31b is a rod-shaped light guide which has a circular or polygonal cross section and on which the second prism 312 is provided. The light guides 31a and 31b may be curved to match the surface shape of the instrument panel 20.

End faces on both sides of the light guides 31a and 31b serve as light intake surfaces, in the same manner as the light guide 11. Light emitted from the light-emitting devices 10 enters into the light guides 31a and 31b from the end faces on both sides and propagates in the length direction of the light guides 31a and 31b. Light propagating inside the light guide 31a is output in the first direction D1 from the light guide 31a by being reflected at the first prism 311, and light propagating inside the light guide 31b is output in the second direction D2 from the light guide 31b by being reflected at the second prism 312.

The outer lens 32 is formed of a material which can transmit the light emitted from the light-emitting device 10, such as PC (polycarbonate). The outer lens 32 is provided to cover the light extraction side of the light guide 31a so that the longitudinal direction thereof is along the longitudinal direction of the light guide 31a. In case that the light guide 31a is curved to match the surface shape of the instrument panel 20, the outer lens 32 is also curved to match the shape of the light guide 31a.

The outer cover 34 is formed of a material which does not transmit the light emitted from the light-emitting devices 10, such as PCABS colored black or white. The outer cover 34 is arranged to partially cover an upper side of the light guide 31b on the light extraction side so that light emitted from the light guide 31b and travelling not toward the upper surface 221 of the lower panel 22 but directly toward the opening of the space 23 is blocked. In case that the light guide 31b is curved to match the surface shape of the instrument panel 20, the outer cover 34 is also curved to match the shape of the light guide 31b.

The housing 33 is formed of a material which does not transmit the light emitted from the light-emitting devices 10, such as PCABS colored black or white.

Alternatively, the lighting device of the invention may output light in the first direction D1 as well as in the second direction D2 from, e.g., a spot light source without through the light guide. In this case, a lamp unit with a circular lens is prepared as the spot light source and is installed in the space 23 of the instrument panel 20 so that its optical axis is oriented along the first direction D1. This results in that light traveling on the optical axis becomes direct light directly visually perceived by an occupant sitting in the seat 26 and a portion of light diffusing from the circular lens becomes indirect light that travels in the second direction D2, is reflected at the upper surface 221 of the lower panel 22 and is then visually perceived by the occupant. In this regard, in such a configuration, the lamp unit is preferably placed in an orientation in which a copper wire extending from a connector does not touch the lower panel 22 (an orientation in which the circular lens is located on the lower side and the connector opposite thereto is hidden behind the upper panel 21) so that an area of a design portion (the circular lens of the lamp unit and the periphery thereof) visually perceived by the occupant is reduced.

### Effects of the Embodiment

The lighting device in the embodiment of the invention has both a direct lighting function by light output in the first direction D1 and an indirect lighting function by light output in the second direction D2. Therefore, the lighting device in the embodiment of the invention can be used in a wide range of applications such as notification to occupants and ambient illumination.

Although the embodiment of the invention has been described, the invention is not limited to the embodiment described above and the various kinds of modifications can be implemented without departing from the gist of the invention. In addition, the constituent elements in the embodiment can be arbitrarily combined without departing from the gist of the invention.

In addition, the embodiment described above does not limit the invention according to claims. Further, please note that not all combinations of the features described in the embodiment are necessary to solve the problem of the invention.

1. A lighting device to be installed on an instrument panel in a vehicle cabin,
wherein the lighting device is configured to emit light in a first direction toward a seat in the vehicle cabin so as to be directly visually perceived by an occupant sitting in the seat and to emit light in a second direction toward an interior of the vehicle cabin so as to be reflected by the interior and then visually perceived by the occupant.

2. The lighting device according to claim 1, comprising:
a light source that emits light; and
a light guide that takes in light emitted from the light source and allows the light to propagate therethrough and to be output,
wherein the light guide comprises a first prism to reflect and output light propagating therethrough in the first direction, and a second prism to reflect and output light propagating therethrough in the second direction.

3. The lighting device according to claim 2, further comprising:
an outer lens comprising a material transparent to light emitted from the light source,
wherein the outer lens comprises a first flat plate portion to transmit the light output from the light guide in the first direction and a second flat plate portion to transmit the light output from the light guide in the second direction.
